(19) United States
(12) Patent Application Publication
(10) Pub. No.: US 2018/0173610 A1
(43) Pub. Date: Jun. 21, 2018

(54) METHOD FOR PERFORMING CARED-ZONE CODE COVERAGE EVALUATION WITH NO SOURCE CODE MODIFICATION

(71) Applicant: MEDIATEK INC., Hsin-Chu (TW)

(72) Inventors: Kuo-Cheng Lee, New Taipei City (TW); Yen-Hwei Hsieh, Taoyuan City (TW)

(21) Appl. No.: 15/382,761

(22) Filed: Dec. 19, 2016

(51) Int. Cl. G06F 11/36

(52) U.S. Cl. CPC G06F 11/3636; G06F 11/3664; G06F 11/3676

(57) ABSTRACT

A code coverage processing method includes: receiving a source code; executing a program according to the source code, wherein the source code is categorized into basic blocks, and each line included in a same basic block is executed a same number of times; creating a line tracking file having a plurality of line tracking records for a plurality of lines of the source code, respectively, wherein each of the line tracking records indicates how many times a corresponding line in the source code has been executed; receiving a non-cared zone setting which indicates at least one of the basic blocks in the source code is selected as a part of a non-cared zone; computing a code coverage result of the source code according to the line tracking file and the non-cared zone setting; and providing the code coverage result.

### BACKGROUND

The present invention relates to code coverage, and more particularly, to a method for performing cared-zone code coverage evaluation with no source code modification.

In computer science, code coverage is a measure used to describe the degree to which a source code of a program is executed when a particular test pattern is used to test the execution of the program. A program with high code coverage, measured as a percentage, has more of its source code executed during testing, which suggests that it has a lower chance of containing undetected bugs compared to a program with low code coverage.

The source code of one program may include different code segments developed by different software engineers (or different software development teams). When the program is tested, one software engineer (or one software development team) maybe interested in code coverage for only one code segment of the source code. Hence, there is a need for computing code coverage of the interested code segment only.

### SUMMARY

One of the objectives of the claimed invention is to provide a method for performing cared-zone code coverage evaluation with no source code modification.

According to a first aspect of the present invention, an exemplary code coverage processing method is disclosed. The exemplary code coverage processing method includes: receiving a source code written in a predetermined programming language; executing a program according to the source code, wherein the source code is categorized into basic blocks, and each line included in a same basic block is executed a same number of times; creating a line tracking file comprising a plurality of line tracking records for a plurality of lines of the source code, respectively, wherein each of the line tracking records indicates how many times a corresponding line in the source code has been executed; receiving a non-cared zone setting which indicates at least one of the basic blocks in the source code is selected as a part of a non-cared zone; computing a code coverage result of the source code according to the line tracking file and the non-cared zone setting; and providing the code coverage result.

According to a second aspect of the present invention, an exemplary code coverage processing method is disclosed. The exemplary code coverage processing method includes: receiving a source code written in a predetermined programming language; executing a program according to the source code, wherein the source code is categorized into basic blocks, each line included in a same basic block is executed a same number of times, at least a basic block tracking file is created by executing the program according to the source code, and the basic block tracking file records information indicative of how many times each basic block in the source code has been executed; receiving a non-cared zone setting which indicates at least one of the basic blocks in the source code is selected as a part of a non-cared zone; generating a modified basic block tracking file based on the basic block file by modifying recorded information associated with the at least one of the basic blocks that belongs to the non-cared zone; computing a code coverage result of the source code according to at least the modified basic block tracking file; and providing the code coverage result.

According to a third aspect of the present invention, an exemplary code coverage processing method is disclosed. The exemplary code coverage processing method includes: receiving a source code written in a predetermined programming language; executing a program according to the source code, wherein the source code is categorized into basic blocks, each line included in a same basic block is executed a same number of times, a basic block tracking file is created by executing the program according to the source code, and the basic block tracking file records basic block tracking information indicative of how many times each basic block in the source code has been executed; receiving a non-cared zone setting which indicates at least one of the basic blocks in the source code is selected as apart of a non-cared zone; computing a code coverage result according to the basic block tracking file, without considering basic block tracking information associated with the at least one of the basic blocks that belongs to the non-cared zone indicated by the non-cared zone setting, wherein no modification is made to the basic block tracking file according to the non-cared zone setting; and providing the code coverage result.

According to a fourth aspect of the present invention, an exemplary code coverage processing method is disclosed. The exemplary code coverage processing method includes: receiving a source code written in a predetermined programming language; executing a program according to the source code, wherein the source code is categorized into basic blocks, and each line included in a same basic block is executed a same number of times; receiving a non-cared zone setting which indicates at least one of the basic blocks in the source code is selected as a part of a non-cared zone; computing a code coverage result of the source code excluding lines belonging to the non-cared zone; and providing the code coverage result. The step of receiving the non-cared zone setting includes: providing at least a portion of the source code on a display screen; while said at least a portion of the source code is being provided on the display screen, receiving at least one user input which selects at least one line of said at least a portion of the source code; and treating at least one basic block of the source code that encompasses the at least one line selected by the at least one user input as the non-cared zone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a computer system according to an embodiment of the present invention.

FIG. 2 is a diagram illustrating a first phase of the code coverage evaluation according to an embodiment of the present invention.

FIG. 3 is a diagram illustrating a source code categorized into basic blocks according to an embodiment of the present invention.

FIG. 4 is a diagram illustrating a text file representing a basic block file according to an embodiment of the present invention.

FIG. 5 is a diagram illustrating a text file representing a basic block tracking file according to an embodiment of the present invention.

FIG. 6 is a diagram illustrating a second phase of the code coverage evaluation according to an embodiment of the present invention.

FIG. 7 is a diagram illustrating a line tracking file that is a text file according to an embodiment of the present invention.

FIG. 8 is a diagram illustrating a third phase of the code coverage evaluation according to an embodiment of the present invention.

FIG. 9 is a diagram illustrating non-cared zone selection according to an embodiment of the present invention.

FIG. 10 is a diagram illustrating a modified first phase of the code coverage evaluation according to an embodiment of the present invention.

FIG. 11 is a diagram illustrating a text file representing a modified basic block file according to an embodiment of the present invention.

FIG. 12 is a diagram illustrating a text file representing a modified basic block tracking file according to an embodiment of the present invention.

FIG. 13 is a diagram illustrating a modified second phase of the code coverage evaluation according to an embodiment of the present invention.

FIG. 14 is a diagram illustrating a modified line tracking file that is a text file according to an embodiment of the present invention.

FIG. 15 is a diagram illustrating a modified third phase of the code coverage evaluation according to an embodiment of the present invention.

FIG. 16 is a diagram illustrating a first modified code coverage evaluation design for a Java source code according to an embodiment of the present invention.

FIG. 17 is a diagram illustrating a second modified code coverage evaluation design for a Java source code according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

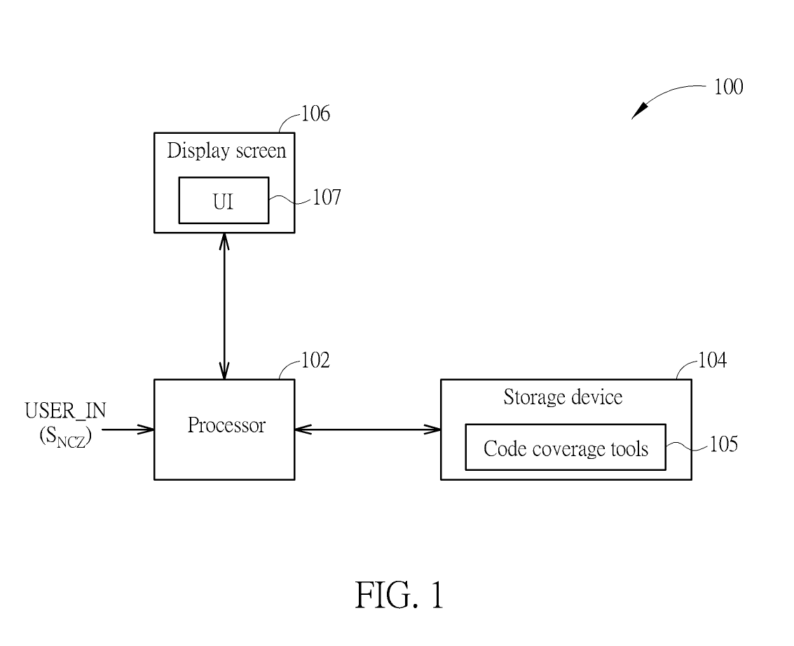

FIG. 1 is a diagram illustrating a computer system according to an embodiment of the present invention. The computer system 100 is capable of providing a software development environment, and includes a processor 102, a storage device 104, and a display screen 106. It should be noted that only the components pertinent to the present invention are shown in FIG. 1. In practice, the computer system 100 can include additional circuits for achieving other functions. The storage device 104 is used to store software modules, including one or more code coverage tools 105. For example, the code coverage tools 105 may include a compiler, a code coverage analyzing tool, and/or a code coverage report tool; and the storage device 104 may be a hard disk drive, a non-volatile memory, or any data storage means. When the code coverage tools 105 are loaded and executed by the processor 102, the processor 102 is instructed to perform code coverage evaluation and generate a code coverage result to the display screen 106. A user interface (UI) 107 may be provided (e.g., displayed) on the display screen 106, such that the user may interact with the UI 107 to control the code coverage evaluation, and may view the code coverage result through the UI 107. For example, a user input USER IN includes a non-cared zone setting S_{NCZ} that indicates a non-cared zone in a source code (i.e., uninterested lines of the source code), and the proposed cared-zone code coverage processing method can refer to the non-cared zone setting S_{NCZ} to generate and display a code coverage result of a cared zone in the source code (i.e., interested lines of the source code), where the source code is composed of the cared zone and the non-cared zone. Further details of the proposed cared-zone code coverage processing method are described later.

A source code is written in a predetermined programming language. For better understanding of technical features of the present invention, an exemplary source code foo.c (which is written in a C programming language and is to be tested for code coverage evaluation) is given as below. It should be noted that this is for illustrative purposes only, and is not meant to be a limitation of the present invention.

| | |
|---|---|
| 1 | int main( ) |
| 2 | { |
| 3 | int a, b; |
| 4 | a = 10; |
| 5 | b = 2; |
| 6 | |
| 7 | if (b == 2) |
| 8 | a = a+b; |
| 9 | else |
| 10 | a = a−b; |
| 11 | |
| 12 | return a; |
| 13 | } |

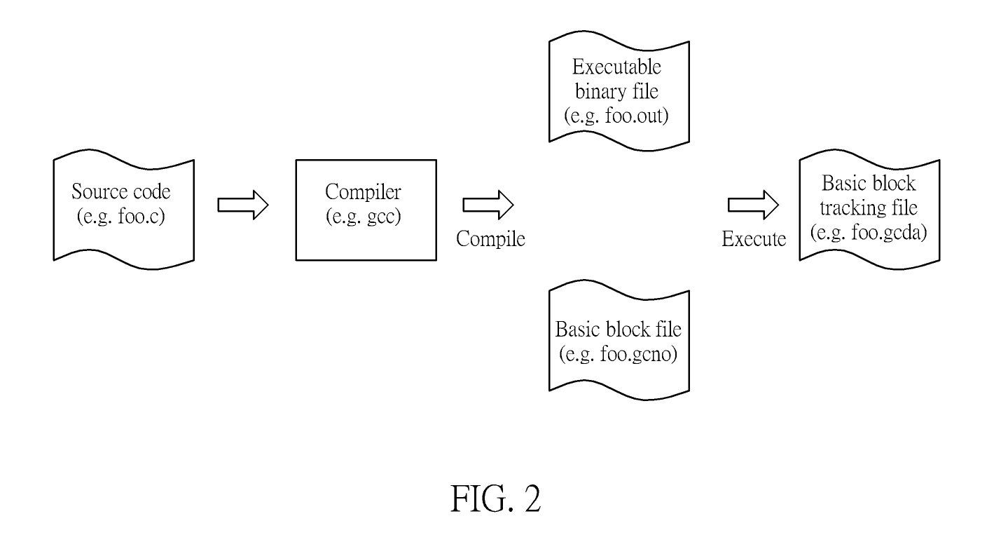

The code coverage evaluation for a C source code may include a plurality of phases. FIG. 2 is a diagram illustrating a first phase of the code coverage evaluation according to an embodiment of the present invention. A compiler (e.g., gcc) is one of the code coverage tools 105. When the user enables a compilation function of the source code foo.c, the compiler is loaded and executed by the processor 102. The compiler gcc running on the processor 102 receives the source code foo.c, and outputs an executable binary file (e.g., foo.out) and a basic block file (e.g., foo.gcno) according to the source code foo.c. For example, the compiler gcc compiles the source code foo.c to generate the executable binary file foo.out, wherein code instrumentation for code coverage is added during the compilation of the source code foo.c. The compiler gcc categorizes the source code foo.c into basic blocks, where each line included in the same basic block will be executed the same number of times. In addition to the executable binary file foo.out, the compilation of the source code foo.c further creates the basic block file foo.gcno that records information of the basic blocks in the source code foo.c.

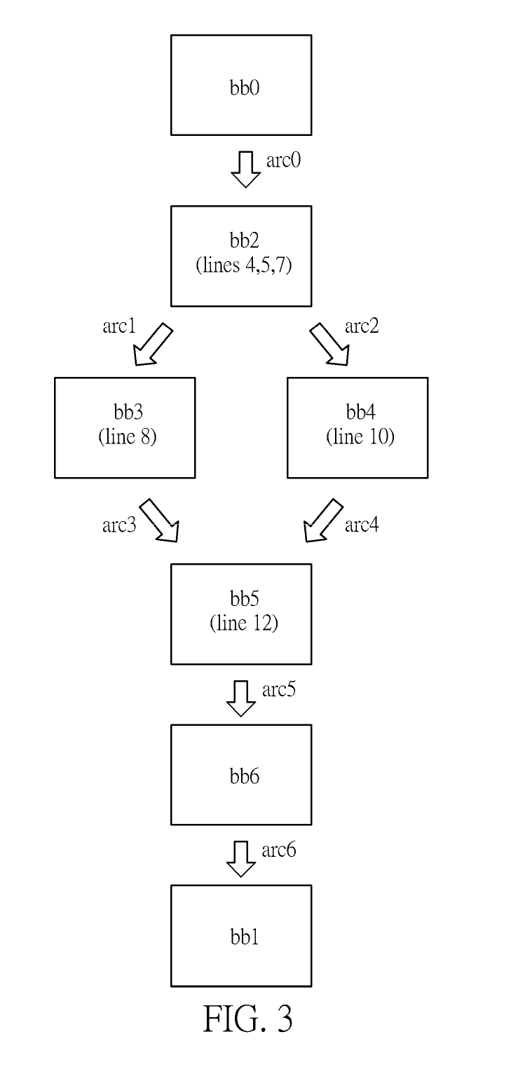

FIG. 3 is a diagram illustrating a source code (e.g., foo.c) categorized into basic blocks according to an embodiment of the present invention. The basic blocks shown in FIG. 3 are for illustrative purposes only. That is, FIG. 3 is merely used to illustrate the relationship of different basic blocks. In practice, the source code (e.g., foo.c) is not necessarily categorized into the basic blocks shown in FIG. 3. For example, in accordance with an actual design of a compiler, the source code (e.g., foo.c) may be categorized into basic blocks different from that shown in FIG. 3. To put is simply, any means capable of categorizing a source code into basic blocks may be employed by the present invention. A basic block (bb) is consisted of one or more expressions that are called/executed atomically, that is, there is no branching between them. An arc (alternatively, edge or branch) specifies a pair of basic blocks (source bb, destination bb), thus indicating which one basic block jumps to which other basic block. In this embodiment, the aforementioned exemplary source code foo.c may be categorized into basic blocks bb0, bb1, bb2, bb3, bb4, bb5 and bb6. For example, lines 4, 5, and 7 of the source code foo.c belong to the same basic block bb2, line 8 of the source code foo.c belongs to the basic block bb3, line 10 of the source code foo.c belongs to the basic block bb4, and line 12 of the source code foo.c belongs to the basic block bb5. As shown in FIG. 3, arc0 specifies (source bb, destination bb)=(bb0, bb2), arc1 specifies (source bb, destination bb)=(bb2, bb3), arc2 specifies (source bb, destination bb)=(bb2, bb4), arc3 specifies (source bb, destination bb)=(bb3, bb5), arc4 specifies (source bb, destination bb)=(bb4, bb5), arc5 specifies (source bb, destination bb)=(bb5, bb6), and arch specifies (source bb, destination bb)=(bb6, bb1).

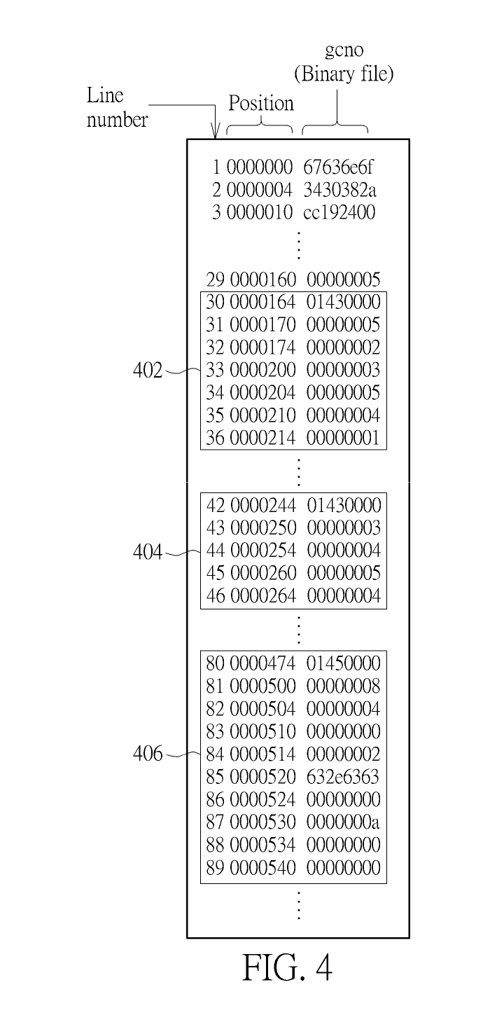

FIG. 4 is a diagram illustrating a text file representing a basic block file (e.g., foo.gcno) according to an embodiment of the present invention. The basic block file foo.gcno generated from the compiler gcc is a binary file which may record information of basic blocks in a source code foo.c and may further record information of associated arcs in the source code foo.c. For illustrative purposes, the basic block file foo.gcno is converted into a text file and then illustrated in FIG. 4. In other words, the text file shown in FIG. 4 is not exactly the basic block file foo.gcno, and the basic block file foo.gcno may be a binary file output from the compiler. The first field indicates line numbers of lines in the text file, the second field indicates positions (which are represented using octal notation) in the binary file, and the third field shows 4-byte binary contents of the basic block file foo.gcno, where each digit of a 4-byte binary content is represented using hexadecimal notation.

In this example, the data segment 404 contains information of arc4 shown in FIG. 3. The 4-byte binary content “01430000” in line 42 of the text file indicates that following 4-byte binary contents have arc information. The 4-byte binary content “00000003” in line 43 of the text file indicates that the data length of the arc information is 3, meaning that the following three 4-byte binary contents indicate a source basic block, a destination basic block and an arc flag, sequentially. Hence, the 4-byte binary content “00000004” in line 44 of the text file indicates that the source basic block is bb4, the 4-byte binary content “00000005” in line 45 of the text file indicates that the destination basic block is bb5, and the 4-byte binary content “00000004” in line 46 of the text file indicates the associated arc4 flag.

In this example, the data segment 402 contains information of arc1 and arc2 shown in FIG. 3. The 4-byte binary content “01430000” in line 30 of the text file indicates that following 4-byte binary contents have arc information. The 4-byte binary content “00000005” in line 31 of the text file indicates that the data length of the arc information is 5. Since the data length of the arc information is larger than 3, the following 4-byte binary contents indicate a source basic block, a destination basic block 1, an arc1 flag, a destination basic block 2, and an arc2 flag, sequentially. Hence, the 4-byte binary content “00000002” in line 32 of the text file indicates that the source basic block is bb2, the 4-byte binary content “00000003” in line 33 of the text file indicates that the destination basic block 1 is bb3, the 4-byte binary content “00000005” in line 34 of the text file indicates the associated arc1 flag, the 4-byte binary content “00000004” in line 35 of the text file indicates that the destination basic block 2 is bb4, and the 4-byte binary content “00000001” in line 36 of the text file indicates the associated arc2 flag.

In this example, the data segment 406 contains information of bb4 shown in FIG. 3. The 4-byte binary content “01450000” in line 80 of the text file indicates that following 4-byte binary contents have basic block information. The 4-byte binary content “00000008” in line 81 of the text file indicates that the data length of the basic block information is 8. Hence, the 4-byte binary content “00000004” in line 82 of the text file indicates that the sequence number of this basic block is 4, and the 4-byte binary content “0000000a” in line 87 of the text file indicates that line 10 of the source code is included in this basic block.

As shown in FIG. 2, a program of the source code foo.c is executed by running the executable binary file foo.out on the processor 102. Since code instrumentation for code coverage is added by the compiler gcc during the compilation of the source code foo.c, a basic block tracking file (e.g., foo.gcda) is also created by running the executable binary file foo.out, where the basic block tracking file foo.gcda records information indicative of how many times each basic block in the source code foo.c has been executed. In other words, the basic block tracking file foo.gcda records information associated with execution counts of the basic blocks in the source code foo.c.

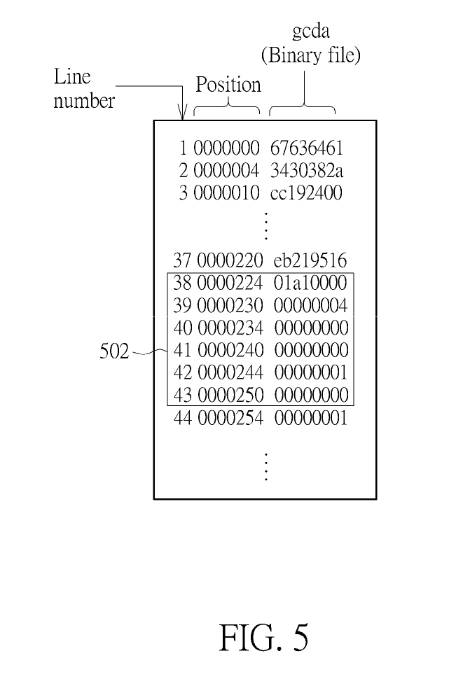

FIG. 5 is a diagram illustrating a text file representing a basic block tracking file (e.g., foo.gcda) according to an embodiment of the present invention. The basic block tracking file foo.gcda generated from execution of the executable binary file foo.out is a binary file. For illustrative purposes, the basic block tracking file foo.gcda is converted into a text file and then illustrated in FIG. 5. In other words, the text file shown in FIG. 5 is not exactly the basic block tracking file foo.gcda, and the basic block tracking file foo.gcda may be a binary file output from execution of the executable binary file foo.out. The first field indicates line numbers of lines in the text file, the second field indicates positions (which are represented using octal notation) in the binary file, and the third field shows the 4-byte binary contents of the basic block tracking file foo.gcno, where each digit of a 4-byte binary content is represented using hexadecimal notation. As can be known from FIG. 3, the execution counts of arc0, arc1, arc2, arc5 and arc6 can be easily deduced when the execution counts of arc3 and arc4 are known. Hence, execution counts of basic blocks bb0-bb6 can be deduced after execution counts of arc3 and arc4 are known. For example, arc3 and arc4, execution counts of which can be used to deduce the execution counts of basic blocks bb0-bb6, may be selected to record their execution counts, such that storage space to keep tracking data may be further reduced. In some embodiments, the way to determine at least one instrumented arc (e.g., arc3 and arc4) among all arcs may be used to select at least one arc to record its execution count . . . . The execution counts of arc3 and arc4 recorded in the basic block tracking file foo.gcda may be regarded as information indicative of how many times each basic block in the source code has been executed. When the execution counts of all instrumented arcs (e.g., arc3 and arc4) are recorded in the basic block tracking file foo.gcda, the execution counts of all basic blocks (e.g., bb0-bb6) can be derived from the execution counts of all instrumented arcs (e.g., arc3 and arc4). In this example, since the execution counts of all instrumented arcs (e.g., arc3 and arc4) can indicate the execution counts of all basic blocks (e.g., bb0-bb6), the basic block tracking file foo.gcda may only record the execution counts of all instrumented arcs (e.g., arc3 and arc4) to save the file size. However, this is for illustrative purposes only, and is not meant to be a limitation of the present invention.

In this example, the data segment 502 contains information of instrumented arcs (e.g., arc3 and arc4) shown in FIG. 3. The 4-byte binary content “01a10000” in line 38 of the text file indicates that following 4-byte binary contents have instrumented arc information. The 4-byte binary content “00000004” in line 39 of the text file indicates that the data length of the instrumented arc information is 4. Information of each instrumented arc is recorded using two 4-byte binary contents. Hence, two 4-byte binary contents in lines 40 and 41 of the text file record that the execution count of arc4 is 0, and two 4-byte binary contents in lines 42 and 43 of the text file record that the execution count of arc3 is 1. The instrumented arcs (e.g., arc3 and arc4) are ordered by the same sorting algorithm used in the code coverage tools. For example, the order of the instrumented arcs (e.g., arc3 and arc4) is followed by both of the compiler and the code coverage analyzing tool. In this way, there is no need to add identification information associated with the instrumented arcs (e.g., arc3 and arc4) in the basic block tracking file (e.g., foo.gcda).

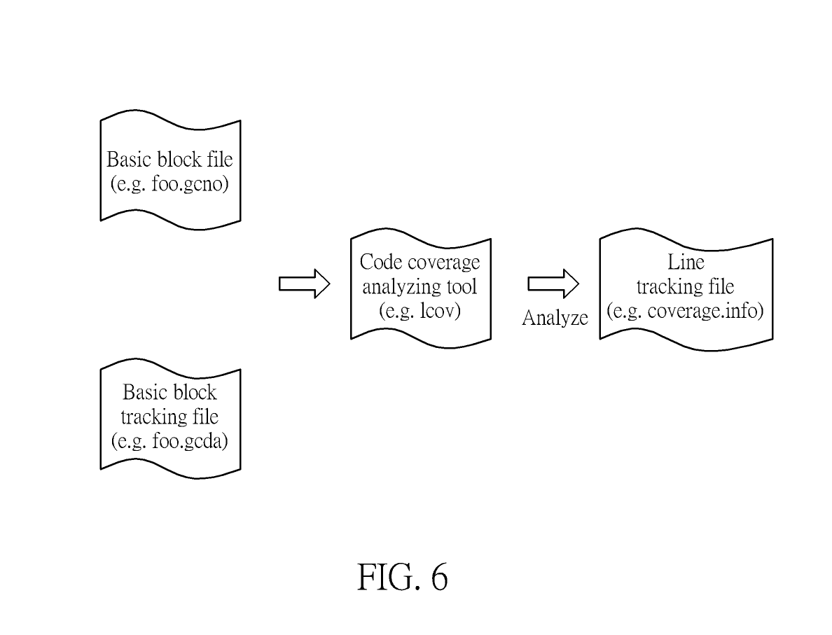

FIG. 6 is a diagram illustrating a second phase of the code coverage evaluation according to an embodiment of the present invention. A code coverage analyzing tool (e.g., lcov) is one of the code coverage tools 105. When the user enables a code coverage analysis function, the code coverage analyzing tool lcov is loaded and executed by the processor 102. The code coverage analyzing tool lcov running on the processor 102 generates a line tracking file (e.g., coverage.info) according to information given from the basic block file foo.gcno and the basic block tracking file foo.gcda. As mentioned above, the basic block file foo.gcno records information of basic blocks in the source code foo.c, and the basic block tracking file foo.gcda records information indicative of how many times each basic block in the source code has been executed. Since each line of the source code is categorized into only one of the basic blocks, the line tracking file coverage.info has a plurality of line tracking records for a plurality of lines of the source code, respectively. Each of the line tracking records indicates how many times a corresponding line in the source code has been executed. For example, each of the line tracking records stores an execution count of a corresponding line in the source code.

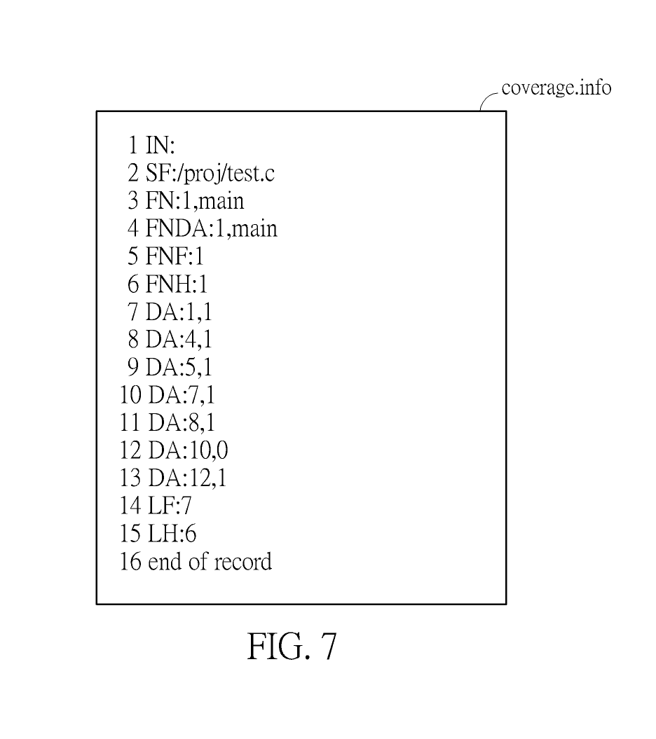

FIG. 7 is a diagram illustrating a line tracking file (e.g., coverage.info) according to an embodiment of the present invention. The line tracking file coverage.info generated from execution of the code coverage analyzing tool lcov may be a plain text file that is human readable. In other words, the exemplary line tracking file coverage.info shown in FIG. 7 may be an output of the execution of the code coverage analyzing tool lcov. However, this is for illustrative purposes only, and is not meant to be a limitation of the present invention. With regard to the aforementioned exemplary source code foo.c, one line tracking record in line 7 of the line tracking file coverage.info shows that line 1 of the source code is executed once, one line tracking record in line 8 of the line tracking file shows thin line 4 of the source code is executed once, one line tracking record in line 9 of the line tracking file shows that line 5 of the source code is executed once, one line tracking record in line 10 of the line tracking file shows that line 7 of the source code is executed once, one line tracking record in line 11 of the line tracking file shows that line 8 of the source code is executed once, one line tracking record in line 12 of the line tracking file shows that line 10 of the source code is not executed, and one line tracking record in line 13 of the line tracking file shows that line 12 of the source code is executed once.

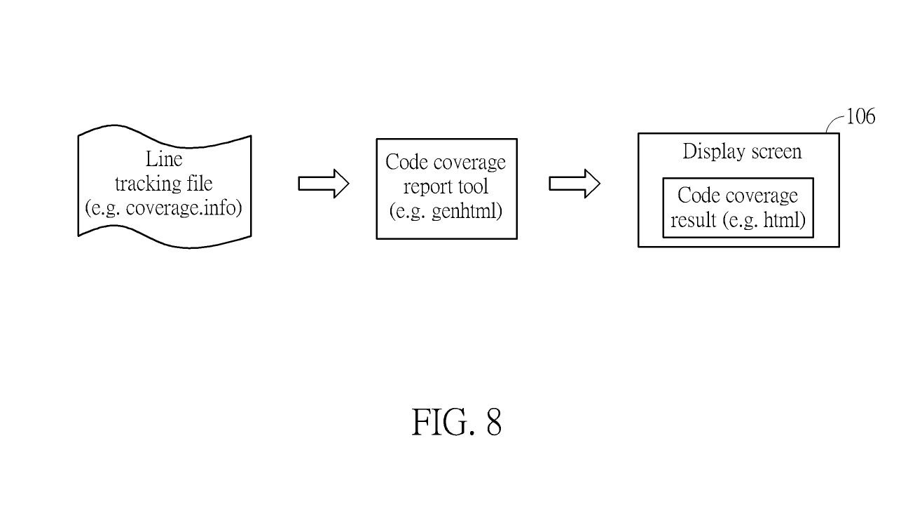

FIG. 8 is a diagram illustrating a third phase of the code coverage evaluation according to an embodiment of the present invention. A code coverage report tool (e.g., genhtml) is one of the code coverage tools 105. When the user enables a code coverage report function, the code coverage report tool genhtml is loaded and executed by the processor 102. The code coverage report tool genhtml running on the processor 102 computes a code coverage result of the source code foo.c according to information given from the line tracking file coverage.info. Next, the generated code coverage result is provided (e.g., displayed) on a display screen (particularly, UI 107 on display screen 106) or presented in some other ways. For example, the code coverage report tool genhtml running on the processor 102 transfers the analysis data in the line tracking file coverage.info into a code coverage result with a human readable format such as an HTML (HyperText Markup Language) format. By way of example, but not limitation, the code coverage result may be an execution percentage of the source code or may be

$$\frac{\begin{matrix}number of lines in the source code that have been executed \\ at least once\end{matrix}}{total number of lines executed} .$$

If the code coverage evaluation is applied to the whole source code, the first phase shown in FIG. 2, the second phase shown in FIG. 6, and the third phase shown in FIG. 8 may be performed, sequentially. However, as mentioned above, a source code may be consisted of a cared zone (which includes interested lines of the source code) and a non-cared zone (which includes uninterested lines of the source code). For example, the source code of one program may include different code segments developed by different software engineers (or different software development teams) ; and when the program is tested, one software engineer (or one software development team) may be interested in code coverage for only one code segment of the source code. The present invention therefore proposes a cared-zone code coverage processing method. The cared-zone code coverage processing method may be performed by the computer system 100 shown in FIG. 1. For example, the code coverage tools 105 stored in the storage device 104 include at least part of or all software tools required to perform or call the proposed cared-zone code coverage processing method. The cared-zone code coverage processing method can refer to the non-cared zone setting S_{NCZ} to generate and display a code coverage result of the cared zone in the source code, without applying any modification to the source code. Since no modification is made to the source code, the cared-zone code coverage processing method has no impact on the maintenance of the source code.

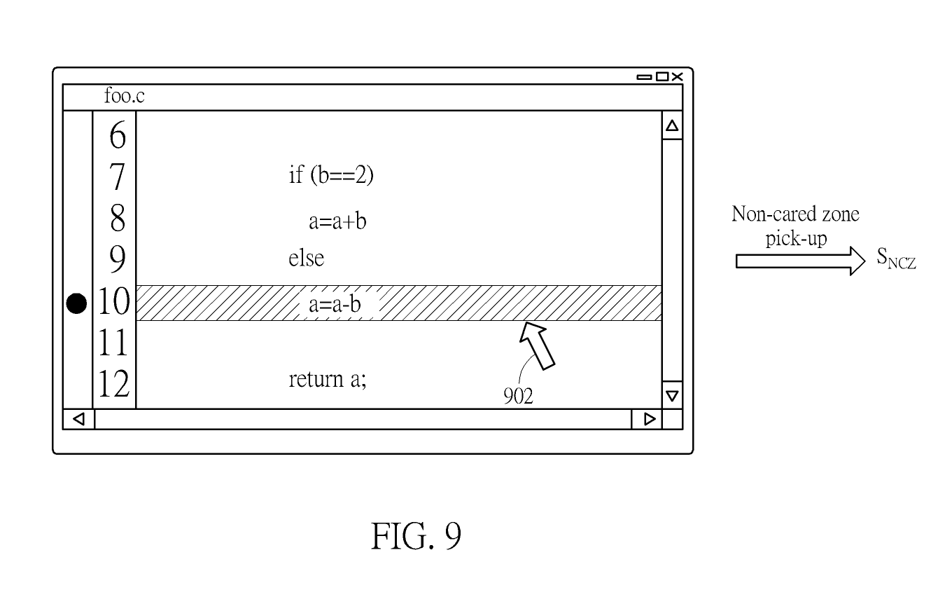

In one exemplary embodiment, the non-cared zone setting S_{NCZ} may be manually determined by the user through UI 107. FIG. 9 is a diagram illustrating non-cared zone selection according to an embodiment of the present invention. A non-cared zone selection tool is one of the code coverage tools 105. Before or during the cared-zone code coverage processing method enabled by the user, the non-cared zone selection tool may be loaded and executed by the processor 102 to generate the non-cared zone setting S_{NCZ} for a source code. At least a portion (i.e., part or all) of a source code under test (e.g., the aforementioned exemplary source code foo.c) may be provided (e.g., displayed) on the display screen 106 for the non-cared zone selection tool running on the processor 102. In this example, the user can control the UI 107 to view different parts of the source code if only a portion of the source code can be shown in the UI 107 at a time. When at least a portion of the source code is being provided (e.g., displayed) on the display screen 106, the non-cared zone selection tool running on the processor 102 receives at least one user input USER IN which selects at least one line of at least a portion of the source code provided/displayed, such that at least one basic block of the source code that encompasses the at least one line selected by the at least one user input USER IN is treated as part of the non-cared zone. In some other embodiments, a cared zone selection tool may be provided to receive at least one user input USER IN which selects at least one line of at least a portion of the source code provided/displayed, and take at least one basic block of the source code that encompasses the at least one line selected by the at least one user input USER IN as part of the cared zone, which should not be limited in this disclosure.

In this example, since line 10 of the source code foo.c is not executed, the user can move a mouse for moving the cursor 902 on the display screen 106, and can click the mouse for selecting the line 10 of the exemplary source code foo.c as a part of the non-cared zone. It should be noted that, due to inherent basic block characteristics, a complete basic block encompassing the selected line 10 of the source code foo.c may be automatically selected as part of the non-cared zone. In a case where a basic block encompassing the selected line 10 of the source code foo.c has other line(s) not selected by the user yet, other line(s) included in the basic block can be automatically selected as part of the non-cared zone without user intervention. In another case where a basic block encompassing the selected line 10 of the source code foo.c has only one line, only the selected line 10 of the source code foo.c is treated as part of the non-cared zone.

For example, the user moves the cursor 902 to the beginning of line 10 of the source code foo.c, and then presses a left button of the mouse to enable the selection of the line 10 of the source code foo.c. For another example, the user moves the cursor 902 to the beginning of line 10 of the source code foo.c, and then presses a right button of the mouse to enable the selection of the line 10 of the source code foo.c. However, these are for illustrative purposes only, and are not meant to be limitations of the present invention. In an alternative design, one or more keyboard keys or any other input device may also be involved in the selection of uninterested lines of a source code (e.g., uninterested line 10 of the source code foo.c).

After all uninterested lines of a source code are selected by the user through the non-cared zone selection tool, the non-cared zone of the source code is determined. The source code is composed of a cared zone and a not-cared zone. Hence, after the non-cared zone of the source code is determined by the non-cared zone setting S_{NCZ}, the cared zone of the source code can be determined correspondingly. At this moment, the non-cared setting S_{NCZ} can be referenced by a cared-zone code coverage tool for achieving cared-zone code coverage evaluation. In some other embodiments, a cared setting can be generated to be referenced by a cared-zone code coverage tool for achieving cared-zone code coverage evaluation, and the cared-zone code coverage tool may generate the non-cared setting S_{NCZ} according to such cared setting.

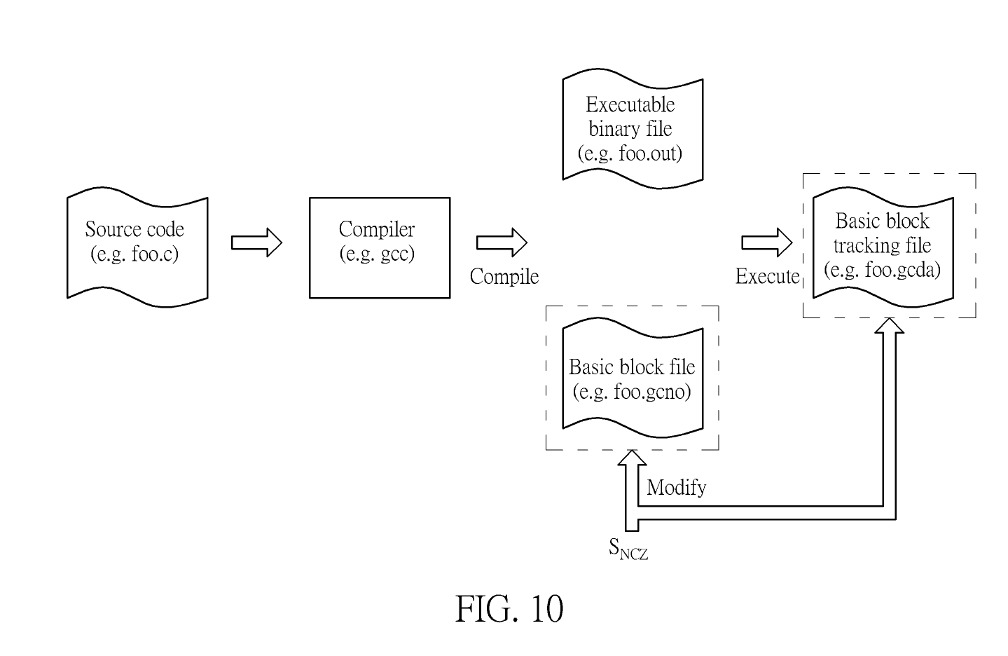

In a first cared-zone code coverage evaluation design, the cared-zone code coverage tool loaded and executed by the processor 102 applies modification to the first phase of the code coverage evaluation shown in FIG. 2. FIG. 10 is a diagram illustrating a modified first phase of the code coverage evaluation according to an embodiment of the present invention. As shown in FIG. 10, the cared-zone code coverage tool running on the processor 102 refers to the non-cared zone setting S_{NCZ} to modify the aforementioned basic block file (e.g., foo.gcno) and basic block tracking file (e.g., foo.gcda). For example, the modified basic block file is generated based on the original basic block file foo.gcno by modifying recorded information associated with at least one of the basic blocks that belongs to the non-cared zone, and the modified basic block tracking file is generated based on the basic block tracking file foo.gcda by modifying recorded information associated with the at least one of the basic blocks that belongs to the non-cared zone.

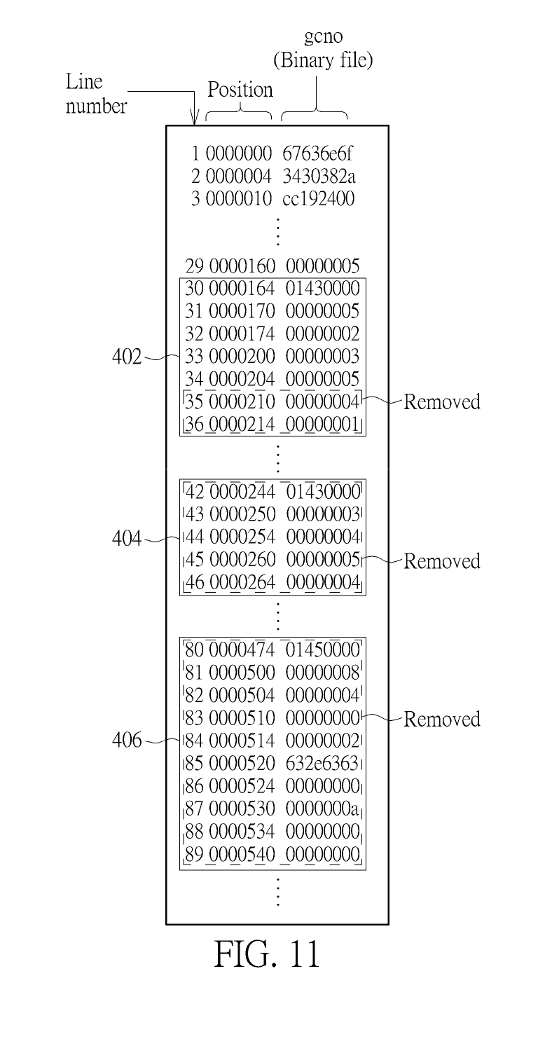

Please refer to FIG. 4 in conjunction with FIG. 11. FIG. 11 is a diagram illustrating a text file representing a modified basic block file according to an embodiment of the present invention. For illustrative purposes, the modified basic block file foo.gcno is converted into a text file and then illustrated in FIG. 11. Specifically, the text file shown in FIG. 11 may be regarded as the text file shown in FIG. 4 with modifications applied thereto. Hence, the text file shown in FIG. 11 is not exactly the modified basic block file foo.gcno which is a binary file output from the proposed modification applied to the first phase of the code coverage evaluation shown in FIG. 2. As shown in FIG. 3, line 10 of the source code foo.c belongs to the basic block bb4. Since the non-cared setting S_{NCZ} indicates that the basic block bb4 (which includes the uninterested line 10 of the source code foo.c) should not be considered by the code coverage evaluation, all 4-byte binary contents in the data segment 404 (which contains information of arc4 shown in FIG. 3) are removed (which means actual binary contents of information of arc4 are removed from the basic block file foo.gcno), and all 4-byte binary contents in the data segment 406 (which contains information of bb4 shown in FIG. 3) are removed (which means actual binary contents of information of bb4 are removed from the basic block file foo.gcno). Since the data segment 402 contains information of arc1 and arc2 shown in FIG. 3 and the non-cared basic block bb4 is associated with arc2, the 4-byte binary contents in the data segment 402 should be properly modified (i.e., the corresponding binary contents actually included in the basic block file foo.gcno should be properly modified) to reflect omission of the non-cared basic block bb4. As mentioned above, the 4-byte binary content in line 31 indicates the data length of the arc information. Since bb4 and the associated arc2 are omitted, the 4-byte binary content “00000005” in line 31 is modified to “00000003” (i.e., the corresponding binary content actually included in the basic block file foo.gcno is modified), meaning that the following 4-byte binary contents indicate one source basic block, one destination basic block and one arc flag, sequentially. In addition, since 4-byte binary contents in lines 35 and 36 record destination basic block information and flag information of arc2, the 4-byte binary contents in lines and 36 are removed (which means actual binary contents of destination basic block information and flag information of arc2 are removed from the basic block file foo.gcno).

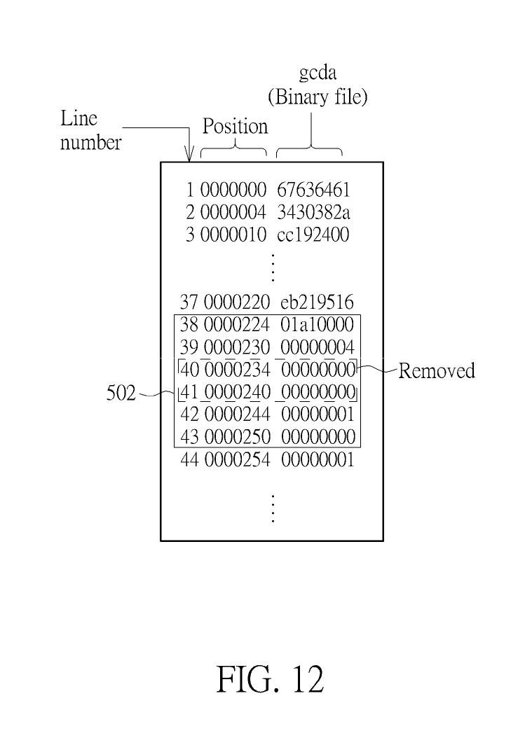

Please refer to FIG. 5 in conjunction with FIG. 12. FIG. 12 is a diagram illustrating a text file representing a modified basic block tracking file according to an embodiment of the present invention. For illustrative purposes, the modified basic block tracking file foo.gcda is converted into a text file and then illustrated in FIG. 12. Specifically, the text file shown in FIG. 12 may be regarded as the text file shown in FIG. 5 with modifications applied thereto. Hence, the text file shown in FIG. 12 is not exactly the modified basic block tracking file foo.gcda which is a binary file output from the proposed modification applied to the first phase of the code coverage evaluation shown in FIG. 2. The non-cared setting S_{NCZ} indicates that the basic block bb4 (which includes the uninterested line 10 of the source code foo.c) should not be considered by the code coverage evaluation. Hence, the data segment 502 that contains information of instrumented arcs (e.g. arc3 and arc4 shown in FIG. 3) should be properly modified (i.e., the corresponding binary contents actually included in the basic block tracking file foo.gcda should be properly modified) to reflect omission of the non-cared basic block bb4. As mentioned above, the 4-byte binary content in line 39 indicates the data length of the arc information. Since information of the instrumented arc3 is sustained, information of the instrumented arc4 is removed and information of each instrumented arc is recorded using two 4-byte binary contents, the 4-byte binary content “00000004” in line 39 is modified to “00000002” (i.e., the corresponding binary content actually included in the basic block tracking file foo.gcda is modified). In addition, since 4-byte binary contents in lines 40 and 41 record execution count information of the instrumented arc4, the 4-byte binary contents in lines 40 and 41 are removed (which means actual binary contents of execution count information of the instrumented arc4 are removed from the basic block tracking file foo.gcda).

The modified first phase of the code coverage evaluation shown in FIG. 10 generates the modified basic block file and the modified basic block tracking file as inputs of the second phase of the code coverage evaluation shown in FIG. 6, such that code coverage analyzing tool creates the line tracking file according to the modified basic block file and the modified basic block tracking file. Hence, the line tracking file created based on the modified basic block file and the modified basic block tracking file has no execution count information of each line in the non-cared zone (e.g., the uninterested line 10 in the source code foo.c). Next, the line tracking file received in the second phase of the code coverage evaluation shown in FIG. 6 is used as an input of the third phase of the code coverage evaluation shown in FIG. 8. Since the line tracking file has no execution count information of each line in the non-cared zone (e.g., the uninterested line 10 in the source code foo.c), the code coverage report tool generates the code coverage result according to execution count information of line(s) in the cared zone only. In this way, the desired cared-zone code coverage result can be received and provided (e.g., displayed by the display screen 106).

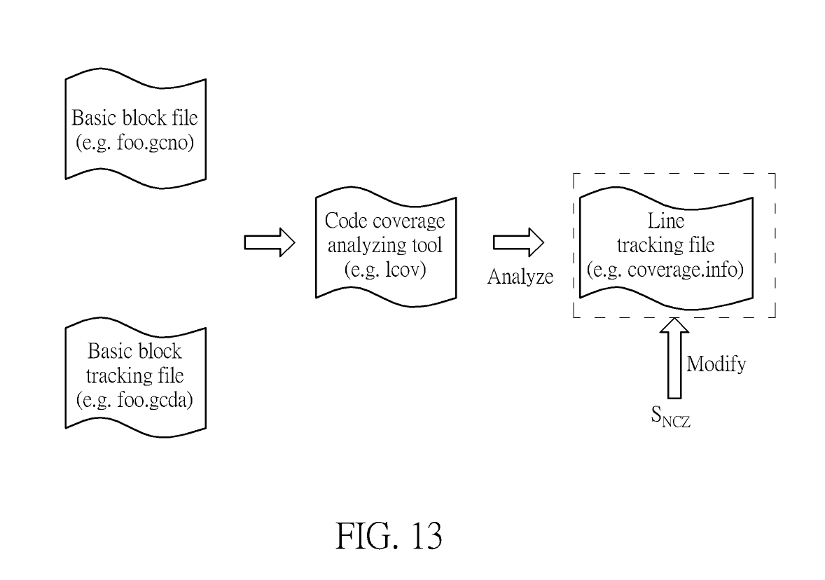

In a second cared-zone code coverage evaluation design, the cared-zone code coverage tool running on the processor 102 applies modification to the second phase of the code coverage evaluation shown in FIG. 6. FIG. 13 is a diagram illustrating a modified second phase of the code coverage evaluation according to an embodiment of the present invention. The basic block file (e.g., foo.gcno) and the basic block tracking file (e.g., foo.gcda) generated by the first phase of the code coverage evaluation shown in FIG. 2 are used as inputs of the modified second phase of the code coverage evaluation. The code coverage analyzing tool generates the line tracking file (e.g., coverage.info) according to the basic block file (e.g., foo.gcno) and the basic block tracking file (e.g., foo.gcda). Next, the cared-zone code coverage tool running on the processor 102 refers to the non-cared zone setting S_{NCZ} to modify the line tracking file. For example, the modified line tracking file is generated by modifying (e.g., removing) line tracking records of lines belonging to the non-cared zone (e.g., one line tracking record of the uninterested line 10 in the source code foo.c).

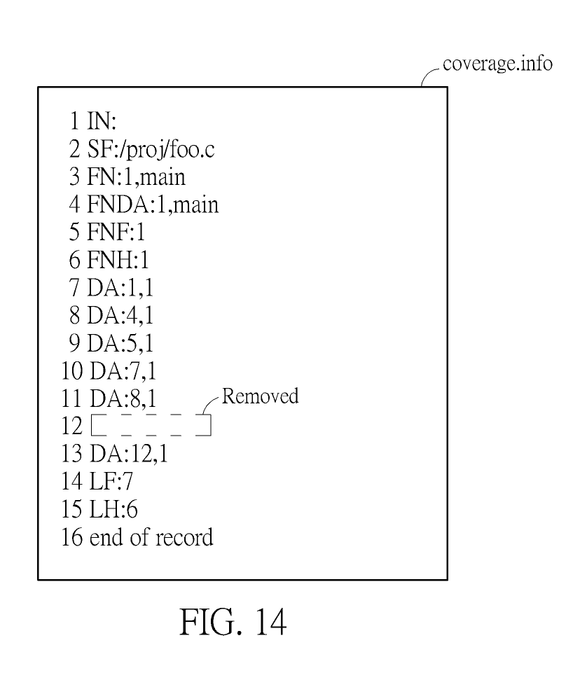

Please refer to FIG. 7 in conjunction with FIG. 14. FIG. 14 is a diagram illustrating a modified line tracking file according to an embodiment of the present invention. As mentioned above, the line tracking file coverage.info generated from execution of the code coverage analyzing tool lcov may be a plain text file that is human readable. Hence, the resulting modified line tracking file coverage.info may also be a plain text file that is human readable. However, this is for illustrative purposes only, and is not meant to be a limitation of the present invention. Since the non-cared setting S_{NCZ} indicates that the basic block bb4 (which includes the uninterested line 10 of the source code foo.c) should not be considered by the code coverage evaluation and the line tracking record of the uninterested line 10 in the source code foo.c is recorded in line 12 of the line tracking file coverage.info, the line tracking record in line 12 of the line tracking file coverage.info is removed.

The modified second phase of the code coverage evaluation shown in FIG. 13 generates the modified line tracking file as an input of the third phase of the code coverage evaluation shown in FIG. 8, such that the code coverage report tool generates the code coverage result according to the modified line tracking file. Since the modified line tracking file has no execution count information of each line in the non-cared zone (e.g., the uninterested line 10 in the source code foo.c), the code coverage report tool generates the code coverage result according to execution count information of line(s) in the cared zone only. In this way, the desired cared-zone code coverage result can be received and provided (e.g., displayed by the display screen 106).

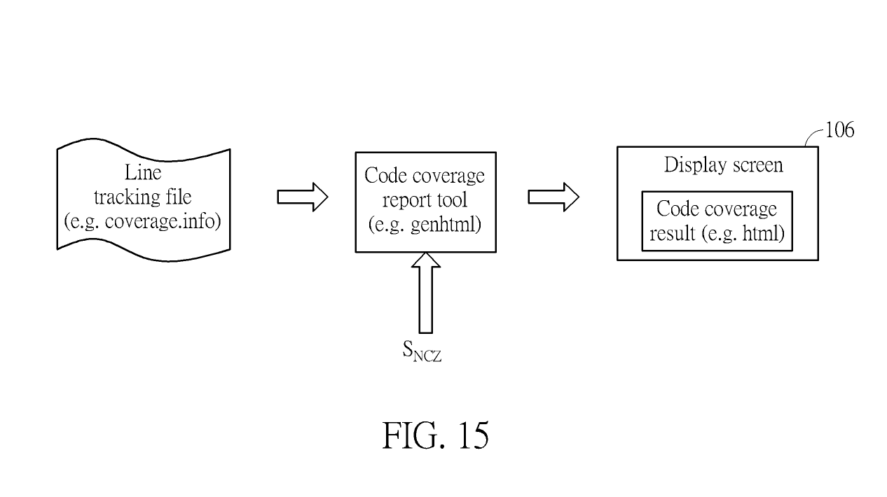

In a third cared-zone code coverage evaluation design, modification is made to the third phase of the code coverage evaluation shown in FIG. 8. FIG. 15 is a diagram illustrating a modified third phase of the code coverage evaluation according to an embodiment of the present invention. The basic block file (e.g., foo.gcno) and the basic block tracking file (e.g., foo.gcda) generated by the first phase of the code coverage evaluation shown in FIG. 2 are used as inputs of the modified second phase of the code coverage evaluation, and the line tracking file (e.g., coverage.info) generated by the second phase of the code coverage evaluation shown in FIG. 6 is used as an input of the modified third phase of the code coverage evaluation. In this embodiment, the code coverage report tool is modified to further receive the non-cared zone setting S_{NCZ}. The modified code coverage report tool running on the processor 102 computes the code coverage result without considering line tracking record(s) of line(s) belonging to the non-cared zone (e.g., one line tracking record of the uninterested line 10 in the source code foo.c) as indicated by the non-cared zone setting S_{NCZ}. It should be noted that there is no modification made to the line tracking file according to the non-cared zone setting S_{NCZ}. The algorithm of the modified code coverage report tool is configured to refer to the non-cared zone setting S_{NCZ} to search the line tracking file for line tracking record(s) of line(s) belonging to the non-cared zone, and is further configured to ignore the found line tracking record(s) of line(s) belonging to the non-cared zone when doing computation of the code coverage result. In other words, though the modified code coverage report tool receive the line tracking file having execution count information of each line in a cared zone and execution count information of each line in a non-cared zone, the modified code coverage report tool computes the code coverage result according to execution count information of line(s) in the cared zone only. In this way, the desired cared-zone code coverage result can be received and provided (e.g., displayed by the display screen 106).

In above examples, the exemplary source code foo.c to be evaluated for its code coverage is written in a C programming language. However, this is for illustrative purposes only, and is not meant to be a limitation of the present invention. The same invention concept may be applied to a source code written in a different programming language (e.g., C++ programming language) for cared-zone code coverage evaluation. The code coverage tools 105 used for performing cared-zone code coverage evaluation upon a source code written in the C++ programming language are almost same as that used for performing cared-zone code coverage evaluation upon a source code written in the C programming language. For example, the C compiler (e.g., gcc) used for compiling the source code written in the C programming language may be replaced by the C++ compiler (e.g., g++) used for compiling the source code written in the C++ programming language. The remaining code conversion tools for cared-zone code coverage evaluation are the same for C source code and C++ source code. Moreover, the program data, including the basic block file, the basic block tracking file and the line tracking file, are the same for C cared-zone code coverage evaluation and C++ cared-zone code coverage evaluation.

Alternatively, the same invention concept may be applied to a source code written in a Java programming language for cared-zone code coverage evaluation. For example, the proposed modification made to the basic block tracking file may be employed to achieve Java cared-zone code coverage evaluation. For another example, the proposed modification made to the code coverage report tool may be employed to achieve Java cared-zone code coverage evaluation.

Due to distinct characteristics between Java programming language and C/C++ programming language, the code coverage evaluation flow for a Java source code may be different from the code coverage evaluation for a C/C++ source code. For example, the code coverage tools 105 may include an interpreter, a JVM (Java virtual machine), and a code coverage report tool (e.g., JaCoCo (Java Code Coverage)). The interpreter translates the Java source code into Java bytecode, and the Java bytecode is executed by JVM. Since the jacoco:coverage object is used under the Java environment, the basic block tracking file (e.g., foo.exec) can be directly generated by JVM and jacoco:coverage object, without any code instrument added during interpretation of the Java source code. It should be noted that, like the basic block tracking file foo.gcda, the basic block tracking file foo.exec is a binary file. Next, the code coverage report tool introduces the jacoco:report object to read and analyze the basic block tracking file foo.exec, thereby generating the code coverage result. It should be noted that the basic block tracking file foo.exec generated during the Java code coverage evaluation is equivalent to a combination of basic block file foo.gcno and basic block tracking file foo.gcda generated during the C/C++ code coverage evaluation, and the Java code coverage evaluation directly generates the code coverage result based on the basic block tracking file foo.exec without creating any line tracking file (which is needed by the C/C++ code coverage evaluation, however).

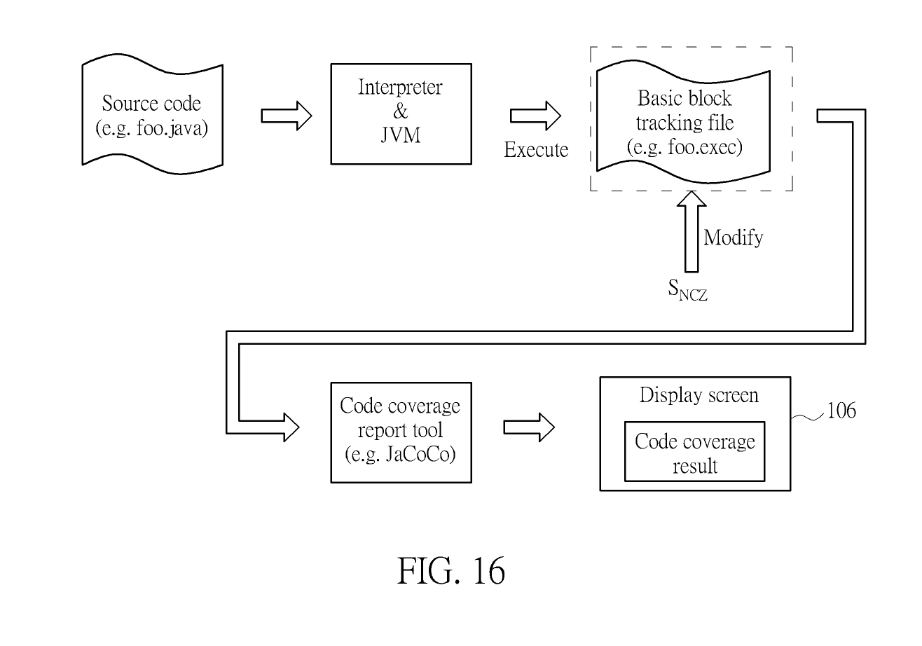

FIG. 16 is a diagram illustrating a first modified code coverage evaluation design for a Java source code according to an embodiment of the present invention. As shown in FIG. 16, the cared-zone code coverage tool running on the processor 102 refers to the non-cared zone setting S_{NCZ} to modify the basic block tracking file (e.g., foo.exec), such that a modified basic block tracking file is used as an input of the code coverage report tool. For example, the modified basic block tracking file is generated based on the basic block tracking file by modifying recorded information associated with at least one of the basic blocks that belongs to the non-cared zone. Since the basic block tracking file has no execution count information of each basic block in the non-cared zone, the code coverage report tool generates the code coverage result according to execution count information of basic block(s) in the cared zone only. In this way, the desired cared-zone code coverage result can be received and provided (e.g., displayed by the display screen 106).

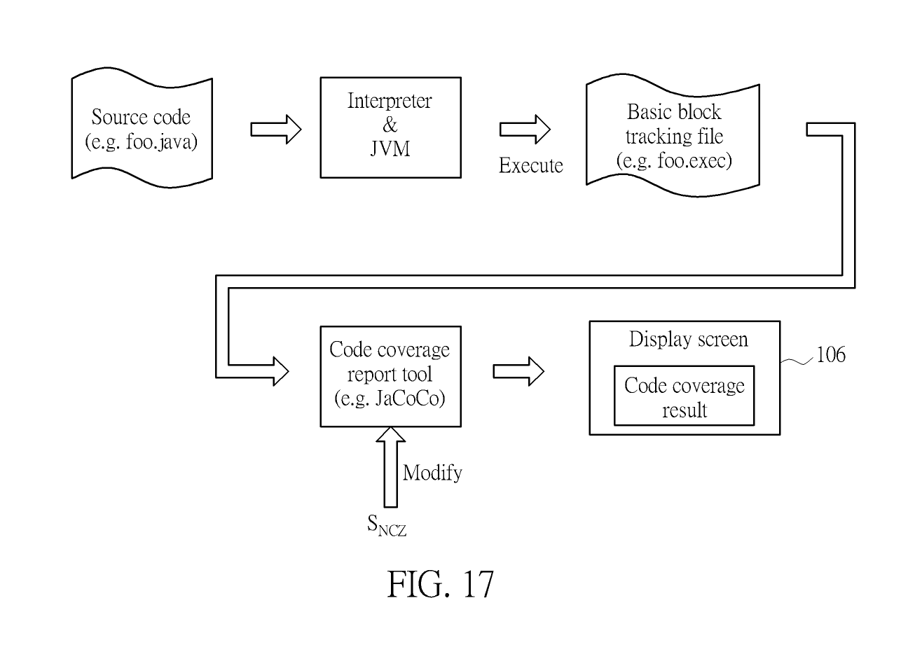

FIG. 17 is a diagram illustrating a second modified code coverage evaluation design for a Java source code according to an embodiment of the present invention. The basic block tracking file (e.g., foo.exec) generated by executing a program of the source code (e.g., foo.java) is used as an input of the modified code coverage report tool. In this embodiment, the code coverage report tool is modified to further receive the non-cared zone setting S_{NCZ}. The modified code coverage report tool running on the processor 102 computes the code coverage result without considering information of basic block(s) belonging to the non-cared zone as indicated by the non-cared zone setting S_{NCZ}. It should be noted that there is no modification made to the basic block tracking file (e.g., foo.exec) according to the non-cared zone setting S_{NCZ}. The algorithm of the modified code coverage report tool is configured to refer to the non-cared zone setting S_{NCZ} to search the basic block tracking file for execution count information of basic block(s) belonging to the non-cared zone, and is further configured to ignore the found execution count information of basic block(s) belonging to the non-cared zone when computing the code coverage result. In other words, though the modified code coverage report tool receives the basic block tracking file having execution count information of each basic block in a cared zone and execution count information of each basic block in a non-cared zone, the modified code coverage report tool computes the code coverage result according to execution count information of basic block(s) in the cared zone only. In this way, the desired cared-zone code coverage result can be received and provided (e.g., displayed by the display screen 106).

In above examples, the same invention concept may be applied to C source code, C++ source code and Java source code for cared-zone code coverage evaluation. However, these are for illustrative purposes only, and are not meant to be limitations of the present invention. In practice, any cared-zone code coverage evaluation design using one of the proposed techniques (e.g., modification of basic block file and basic block tracking file, modification of line tracking file, and modification of code coverage report tool) falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A code coverage processing method comprising:
receiving a source code written in a predetermined programming language;
executing a program according to the source code, wherein the source code is categorized into basic blocks, and each line included in a same basic block is executed a same number of times;
creating a line tracking file comprising a plurality of line tracking records for a plurality of lines of the source code, respectively, wherein each of the line tracking records indicates how many times a corresponding line in the source code has been executed;
receiving a non-cared zone setting which indicates at least one of the basic blocks in the source code is selected as a part of a non-cared zone;
computing a code coverage result of the source code according to the line tracking file and the non-cared zone setting; and
providing the code coverage result.

2. The code coverage processing method of claim 1, wherein computing the code coverage result according to the line tracking file and the non-cared zone setting comprises:
generating a modified line tracking file by modifying line tracking records of lines belonging to the non-cared zone; and
computing the code coverage result according to the modified line tracking file.

3. The code coverage processing method of claim 1, wherein computing the code coverage result according to the line tracking file and the non-cared zone setting comprises:
computing the code coverage result without considering line tracking records of lines belonging to the non-cared zone, wherein no modification is made to the line tracking file according to the non-cared zone setting.

4. The code coverage processing method of claim 1, wherein receiving the non-cared zone setting comprises:
providing at least a portion of the source code on a display screen;
while said at least a portion of the source code is being provided on the display screen, receiving at least one user input which selects at least one line of said at least a portion of the source code; and
treating at least one basic block of the source code that encompasses the at least one line selected by the at least one user input as part of the non-cared zone.

5. The code coverage processing method of claim 1, wherein executing the program according to the source code comprises:
compiling the source code to generate an executable binary file, wherein code instrumentation for code coverage is added during compilation of the source code, a basic block file is created by the compilation of the source code, and the basic block file records information of the basic blocks in the source code; and
executing the program by running the executable binary file, wherein a basic block tracking file is also created by running the executable binary file, and the basic block tracking file records information indicative of how many times each basic block in the source code has been executed; and
creating the line tracking file comprises:
generating the line tracking file according to the basic block file and the basic block tracking file.

6. A code coverage processing method comprising:
receiving a source code written in a predetermined programming language;
executing a program according to the source code, wherein the source code is categorized into basic blocks, each line included in a same basic block is executed a same number of times, at least a basic block tracking file is created by executing the program according to the source code, and the basic block tracking file records information indicative of how many times each basic block in the source code has been executed;
receiving a non-cared zone setting which indicates at least one of the basic blocks in the source code is selected as a part of a non-cared zone;
generating a modified basic block tracking file based on the basic block tracking file by modifying recorded information associated with the at least one of the basic blocks that belongs to the non-cared zone;
computing a code coverage result of the source code according to at least the modified basic block tracking file; and
providing the code coverage result.

7. The code coverage processing method of claim 6, wherein the code coverage result is computed based solely on the modified basic block tracking file.

8. The code coverage processing method of claim 6, wherein executing the program according to the source code comprises:
compiling the source code to generate an executable binary file, wherein code instrumentation for code coverage is added during compilation of the source code, a basic block file is created by the compilation of the source code, and the basic block file records information of the basic blocks in the source code; and
executing the program by running the executable binary file, wherein the basic block tracking file is created by running the executable binary file;
the code coverage processing method further comprises:
generating a modified basic block file based on the basic block file by modifying recorded information associated with the at least one of the basic blocks that belongs to the non-cared zone; and
computing the code coverage result according to at least the modified basic block tracking file comprises:
creating a line tracking file for the source code according to the modified basic block file and the modified basic block tracking file, wherein the line tracking file comprises a plurality of line tracking records for a plurality of lines of the source code, respectively, and each of the line tracking records indicates how many times a corresponding line in the source code has been executed; and
computing the code coverage result according to the line tracking file.

9. A code coverage processing method comprising:
receiving a source code written in a predetermined programming language;
executing a program according to the source code, wherein the source code is categorized into basic blocks, each line included in a same basic block is executed a same number of times, a basic block tracking file is created by executing the program according to the source code, and the basic block tracking file records basic block tracking information indicative of how many times each basic block in the source code has been executed;
receiving a non-cared zone setting which indicates at least one of the basic blocks in the source code is selected as a part of a non-cared zone;
computing a code coverage result according to the basic block tracking file, without considering basic block tracking information associated with the at least one of the basic blocks that belongs to the non-cared zone indicated by the non-cared zone setting, wherein no modification is made to the basic block tracking file according to the non-cared zone setting; and
providing the code coverage result.

10. A code coverage processing method comprising:
receiving a source code written in a predetermined programming language;
executing a program according to the source code, wherein the source code is categorized into basic blocks, and each line included in a same basic block is executed a same number of times;
receiving a non-cared zone setting which indicates at least one of the basic blocks in the source code is selected as a part of a non-cared zone, comprising:
providing at least a portion of the source code on a display screen;
while said at least a portion of the source code is being provided on the display screen, receiving at least one user input which selects at least one line of said at least a portion of the source code; and
treating at least one basic block of the source code that encompasses the at least one line selected by the at least one user input as part of the non-cared zone;
computing a code coverage result of the source code excluding lines belonging to the non-cared zone; and
providing the code coverage result.
